(19) United States
(12) Patent Application Publication
(10) Pub. No.: US 2014/0300280 A1
(43) Pub. Date: Oct. 9, 2014

(54) COLOR-CHANGEABLE LAMP

(71) Applicant: PEGATRON CORPORATION, Taipei City (TW)

(72) Inventors: Yu-Chang CHEN, Taipei City (TW); Kai-Chi SHIU, Taipei City (TW); Chi-Han WANG, Taipei City (TW); Hsin-Hao CHANG, Taipei City (TW)

(73) Assignee: PEGATRON CORPORATION, Taipei City (TW)

(21) Appl. No.: 14/226,342

(22) Filed: Mar. 26, 2014

(30) Foreign Application Priority Data
Apr. 8, 2013 (TW) 102112338

(51) Int. Cl. H05B 33/08

(52) U.S. Cl. CPC H05B 33/0872; H05B 33/0896
USPC 315/158

(57) ABSTRACT

A color-changeable lamp includes a base, a control unit, a deformable lamp body, a color-sensing unit, a pressure-sensing unit and a light-emitting unit. The deformable lamp body is connected with the base and has a closed space. The control unit, the color-sensing unit and the light-emitting unit are disposed at the base. The pressure-sensing unit is disposed in the closed space. The color-sensing unit can sense a color of a target and generate a color signal corresponding to the color of the target, and the pressure-sensing unit can sense the air pressure in the closed space and send a pressure signal to the control unit when the deformable lamp body is deformed. When the pressure signal reaches a predetermined value, the control unit controls the light-emitting unit to emit the light corresponding to the color signal according to the color signal.

### CROSS-REFERENCE TO RELATED APPLICATION

This application claims the priority benefits of Taiwan application serial No. 102112338, filed on Apr. 8, 2013. The entirety of the above-mentioned patent applications are hereby incorporated by references herein and made a part of specification.

### BACKGROUND OF THE INVENTION

Along with the improvement of living standards, mood lamps have become one of the tools for modern people to create joyful lives. Some of the mood lamps create different atmospheres and moods in the room via light sources of different colors to provide users with applications other than lighting. Furthermore, for some of the lights, functional operations are integrated into the structure of the light by combining ingenious exterior design, so that the user can use the light more intuitively or human-friendly.

Please refer to FIG. 1, which is a schematic diagram of a conventional mood lamp 1 disclosed in another patent application (patent application number TW 099129963) filed by the applicant. The mood lamp 1 at least includes a resilient body 11, a switch 12, a processing unit 13, a color-sensing unit 14 and a light-emitting unit 15. During practical operation, a user can press the resilient body 11 directly so that the two electrodes of the switch are in contact with each other to generate a start signal. When the processing unit 13 receives the start signal, it can sense the color of a target with the color-sensing unit 14 and generate a color signal to control the light emitting unit 15 to emit the light corresponding to the color signal. However, in practical application, when pressing the switch 12, beside the wear of the two electrodes, the inner wall of the resilient body 11 is also wore, which causes the reduction of the life of the mood lamp 1. Moreover, to provide the switch 12 inside the resilient body 11 also causes the shadows during illumination, which affect the overall lighting effect and is less attractive.

Therefore, how to provide a lamp which can be operated intuitively, be more durable and with better lighting effect has become an important issue to be solved.

### SUMMARY OF THE INVENTION

In view of the above, an objective of the invention is to provide a color-changeable lamp which can be operated intuitively, be more durable and with better lighting effect.

Another objective of the invention is to provide a color-changeable lamp which has a simple structure without additional control system, and has a low cost.

To achieve the above objectives, the invention provides a color-changeable lamp including a base, a control unit, a deformable lamp body, a color-sensing unit, a pressure-sensing unit and a light-emitting unit. The deformable lamp body is connected with the base and has a closed space. The control unit, the color-sensing unit and the light-emitting unit are disposed at the base. The pressure-sensing unit is disposed in the closed space. Furthermore, the color-sensing unit, the pressure-sensing unit and the light-emitting unit are electrically connected with the control unit.

The color-sensing unit can sense a color of a target and generate a color signal corresponding to the color of the target, and the pressure-sensing unit can sense the air pressure in the closed space to generate a pressure signal and send the pressure signal to the control unit when the deformable lamp body is deformed. When the pressure signal reaches a predetermined value, the control unit controls the light-emitting unit to emit the light corresponding to the color signal.

In one embodiment of the invention, the material of the deformable lamp body is silicone or rubber.

In one embodiment of the invention, the color-changeable lamp further includes a switch and a power supply unit. The switch is disposed at the base and electrically connected with the power supply unit, and the power supply unit is disposed at the base and electrically connected with color-sensing unit, the control unit, the pressure-sensing unit and the light-emitting unit.

In one embodiment of the invention, the light-emitting unit is a light-emitting diode or an organic light-emitting diode.

In one embodiment of the invention, the light-emitting unit is a hybrid red, blue and green light-emitting diode.

In one embodiment of the invention, the color-changeable lamp further includes a wireless transmission unit disposed at the base and electrically connected with the control unit. The wireless transmission unit may be used to send the color signal to another device, such as but not limited to another lamp, so that the another lamp can control its light-emitting unit to emit light corresponding to the color signal according to the color signal.

In one embodiment of the invention, the wireless transmission unit is an infrared ray transmission unit.

In one embodiment of the invention, the color-changeable lamp further includes a lampshade having a charging base and a signal-receiving unit. The lamp may be disposed at the charging base and electrically connected with the charging base. The wireless transmission unit sends the color signal to the signal-receiving unit.

In one embodiment of the invention, the deformable lamp body further includes a neck portion, the neck portion has a thread, and the deformable lamp body is coupled with the base through the thread.

In one embodiment of the invention, the color-sensing unit includes a light source and a receiver.

Based on the above, the color-changeable lamp uses the internal pressure variation when the deformable lamp body is pressed as the basis to initiate the modulation to change the light color of the lamp. Therefore an intuitive, durable and good lighting effect lamp is provided.

### BRIEF DESCRIPTION OF THE DRAWINGS

FIG. 1 is a mood lamp in the prior art.

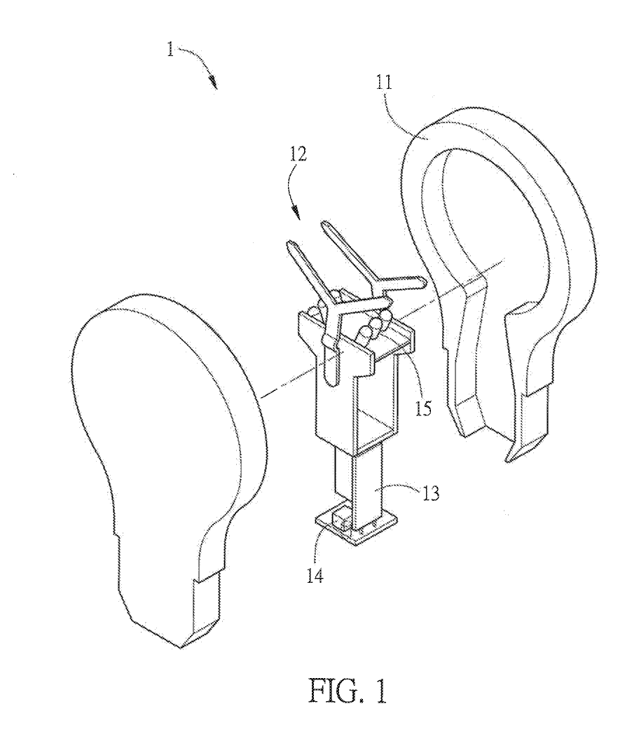

FIG. 2 is a perspective schematic diagram of the color-changeable lamp according to a preferred embodiment of the invention.

FIG. 3 is a partial explosive schematic diagram of the color-changeable lamp according to the preferred embodiment of the invention.

FIG. 4 is an operational schematic diagram of the color-changeable lamp according to the preferred embodiment of the invention.

FIG. 5 is a schematic diagram of the color-changeable lamp according to the preferred embodiment of the invention with a lampshade.

### DETAILED DESCRIPTION OF THE INVENTION

The present invention will be apparent from the following detailed description, which proceeds with reference to the accompanying drawings, wherein the same references relate to the same elements, and elements not directly related to the invention are not shown in the drawings for comprehensive purpose.

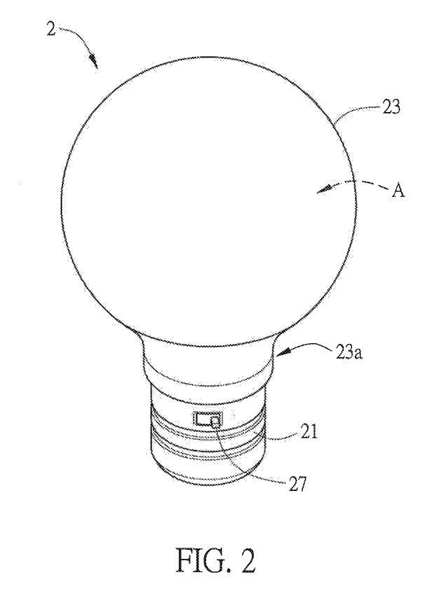

Please refer to FIG. 2 to FIG. 4, which are a perspective schematic diagram, a partial explosive schematic diagram, and an operational schematic diagram of the color-changeable lamp according to the preferred embodiment of the invention, respectively.

The color-changeable lamp 2 of the embodiment at least includes a base 21, a control unit 22, a deformable lamp body 23, a color-sensing unit 24, a pressure-sensing unit 25 and a light-emitting unit 26.

The deformable lamp body 23 is connected with the base 21, and has a closed space A. The closed space A here is an airtight space, so that the internal pressure of the deformable lamp body 23 can be changed after the deformable lamp body 23 is pressed or squeezed. The deformable lamp body 23 can be connected with the base 21 by screwing. For example, the deformable lamp body 23 may further has a neck portion 23a, and the portion of the neck portion 23a contacting with the base 21 is threaded (not shown in the drawing), so that the deformable lamp body 23 may be coupled to the base 21 via the thread.

The material of the deformable lamp body 23 of the embodiment may be silicone or rubber, so that the deformable lamp body 23 can return to its original shape after being deformed. Furthermore, it is possible that the deformable lamp body 23 is not formed by deformable material in its entirety, but formed partially by deformable material and partially by rigid material. In other words, the deformable lamp body may be deformed partially, and the pressure within the closed space A is changed by pressing or squeezing the deformable part. Moreover, the exterior shape of the deformable lamp body 23 is not limited by the drawing. In the present embodiment, the shape of a bulb is selected to meet the concept of a lamp, not to limit the scope of the invention.

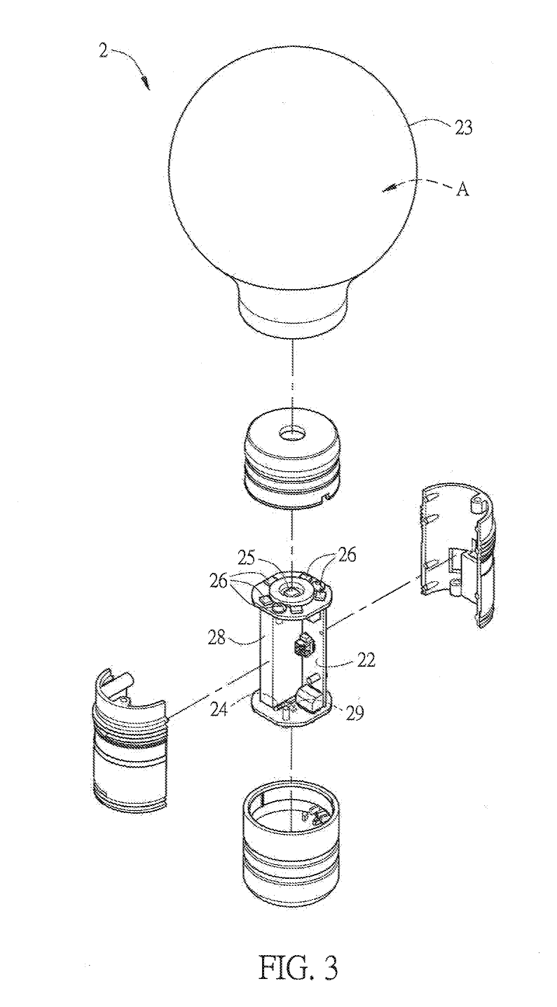

Please refer to FIG. 3 in particular. The control unit 22, the color-sensing unit 24 and the light-emitting 26 are disposed at the base 21. The pressure-sensing unit 25 is disposed in the closed space A. The color-sensing unit 24, the pressure-sensing unit 25 and the light-emitting unit 26 are electrically connected with the control unit 22. In the present embodiment, the control unit 22 may be a microchip, a microprocessor, or a control circuit.

The color-sensing unit 24 may be a component that senses visible light (within a wavelength range from about 400 nm to about 700 nm), and the way it senses visible light is that a light source (not shown in the drawing) of the color-sensing unit 24 emits light, and then the light is received by a receiver (not shown in the drawing) of the color-sensing unit 24 after reflected by a target to determine the wavelength of the light received by the receiver to obtain the color of the target.

Although in the present embodiment the color-sensing unit 24 is disposed in the base 21 and receives light through a transparent glass and a plate body, in other embodiments the color-sensing unit may be partially exposed outside of the base 21 to receive the reflected light and sense the color of the target.

The light-emitting unit 26 is disposed at the top surface of the base 21 and preferably toward the deformable lamp body 23 (as shown in FIG. 3) so that the light emitted by the light-emitting unit 26 passes through the deformable lamp body 23. The number and arrangement of the light-emitting unit 26 are not limited by that shown in the drawing. In the present embodiment, the light-emitting unit 26 may include light-emitting diodes, organic light-emitting diodes, other components that emit visible light, or other components that emit ultraviolet (UV) light which is transformed into visible light through an fluorescent body.

In another aspect of the invention, the light-emitting unit may preferably be a hybrid red, blue and green light-emitting diode, which has independent red, blue and green light-emitting assemblies controlled independently to emit lights of different wavelengths, that is, different colors perceived by a user.

Please refer to FIG. 2 and FIG. 3 together. The color-changeable lamp 2 may further include a switch 27 and a power supply unit 28. The switch 27 is disposed at the base 21 and is electrically connected with the power supply unit 28. The power supply unit 28 is disposed at the base 21 and is electrically connected with the control unit 22, the color-sensing unit 24, the pressure-sensing unit 25 and the light-emitting unit 26. Although the switch 27 is of a push type, in other embodiment the switch 27 may be a rotatable ring disposed at the base 21, which may be turned on and off by rotation. The power supply unit 28 in the present embodiment may be a rechargeable battery.

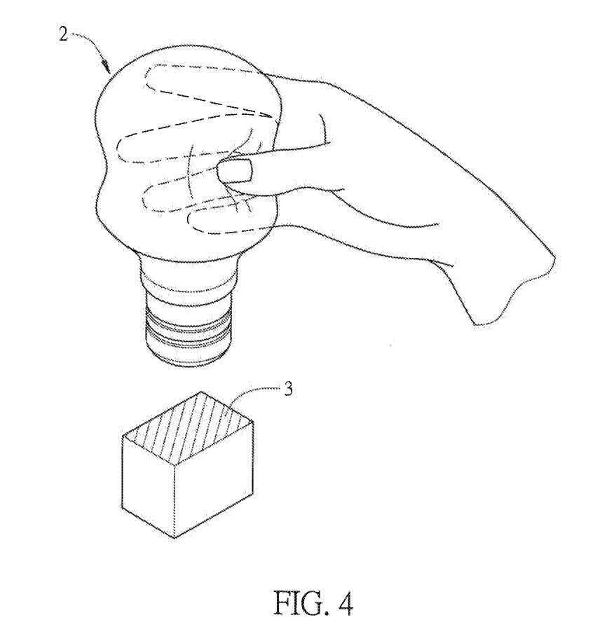

Please refer to FIG. 4. In practical operation, after a user turns on the switch 27 of the color-changeable lamp 2, the light-emitting unit 26 emits a predetermined light (such as a white light). The color-sensing unit 24 starts to sense the wavelength of the reflected light and generates a color signal. In other words, when the user moves the color-sensing unit 24 to get close to and contact with the target 3 (such as a block of the specific hatched area), the color-sensing unit 24 senses the color of the target 3 to obtain the color signal. In the present embodiment, when the switch 27 is turned on, the color-sensing unit 24 keeps measuring the wavelength of the reflected light to generate the color signal corresponding to the target. However, persons having ordinary skill in the art may add another switch to control the operation status of the color-sensing unit 24.

Afterwards, the user may grip the deformable lamp body 23 so that it is forced to be deformed (and the air pressure in the closed space A is changed). At this moment, the pressure-sensing unit 25 may sense the air pressure in the closed space A to generate a pressure signal, and send the pressure signal to the control unit 22. When the pressure signal reaches a predetermined value, the control unit 22 may control the light-emitting unit 26 according to the color signal to make the light-emitting unit 26 emit light corresponding to the color signal toward the deformable lamp body 23. After modulated, the wavelength of the light emitted by the light-emitting unit 26 is substantially the same or close to the wavelength of the target 3, and the user feels that the color-changeable lamp 2 emits light with the color substantially the same to the color of the target 3. Here, the term “substantially the same” means that even the color of the light emitted by the light-emitting unit 26 is slightly different from the color of the target 3, they still cover substantially the same scope. The predetermined value of the pressure signal may be set according to the rigidity of the deformable lamp body 23, which may be done by persons having ordinary skill in the art directly without inconsistency.

The pressure-sensing unit 25 of the color-changeable lamp 2 of the embodiment is used as the component for converting an external operation of the user to an internal control signal to initiate subsequent operations. By such configuration, a more intuitive color-changeable lamp 2 can be obtained. Since the pressure-sensing unit 25 is disposed in the closed space A of the deformable lamp body 23 near the base 21, and the size of the pressure-sensing unit 25 is comparably smaller than the deformable lamp body 23, it does not affect the emitted light and thus no shadow is generated internally. Therefore, it can provide users a better visual effect.

It is noteworthy that the “predetermined value” here may he the variation of the air pressure (ΔP) or the value of the air pressure (P). In other words, when the variation of the air pressure or the value of the air pressure is increased to the predetermined value, the control unit 22 can generate a control signal which makes the light-emitting unit 26 change the color of the emitted light.

Another aspect that should be noted is the concept of “substantially the same wavelength” mentioned herein. It means that due to the limit of the physical structure of the human eyes, lights having wavelengths within a certain range are perceived as having the same color, and those lights perceived as the same color but having different wavelengths after measured by machines are referred to as having “substantially the same wavelength”.

Furthermore, the color-changeable lamp 2 of he embodiment may further includes a wireless transmission unit 29 disposed at the base 21 and electrically connected with the control unit 22. The wireless transmission unit 29 may be an infrared ray transmission unit. The objective of disposing the wireless transmission unit 29 is that when the color-changeable lamp 2 is used with another lamp which also has a receiver (not shown in the drawing), the wireless transmission unit 29 may transmit the color signal sensed by the color-sensing unit 24 to another lamp, so that another lamp may control its light-emitting unit according to the color signal received to emit light corresponding to the color signal received.

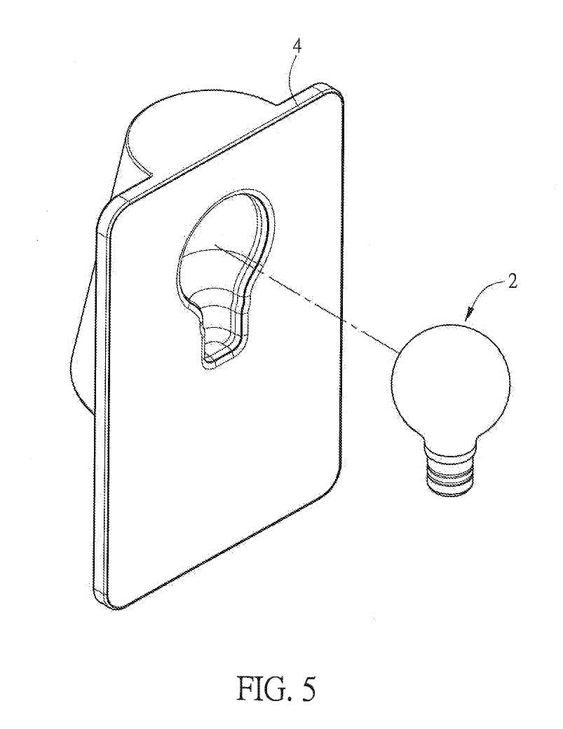

Lastly, please refer to FIG. 5, which is a schematic diagram showing the preferred embodiment of the invention: the color-changeable lamp 2 used with the lampshade 4. The color-changeable lamp 2 may further include a lampshade 4 having a charging base and a signal-receiving unit (not shown in the drawing). The lampshade 4 may also include a light-emitting unit (not shown in the drawing). The lamp 2 may be disposed on the charging base and electrically connected with the charging base to charge the power supply unit 28 in the color-changeable lamp 2. When the power supply unit 28 is in a charging status, the lamp 2 can send the color signal to the signal-receiving unit of the lampshade 4 via the wireless transmission unit 29 to change the color of the light emitted by the light-emitting unit of the lampshade 4 to make its wavelength be substantially the same to the light emitted by the light-emitting unit 26 of the color-changeable lamp 2.

To sum up, the color-changeable lamp is provided with a pressure-sensing unit and a deformable lamp body. Users can change the internal air pressure by pressing the deformable lamp body to generate an internal control signal instructing the control unit to change the color of the lamp light. Therefore a more intuitive and durable lamp with better lighting effect is provided. Furthermore, the configuration of the invention is simple. No additional control system is needed. And we have a low-cost color-changeable lamp.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A color-changeable lamp, comprising:
a base;
a control unit disposed at the base;
a deformable lamp body connected with the base and having a closed space;
a color-sensing unit disposed at the base and electrically connected with the control unit for sensing a color of a target and generating a color signal corresponding to the color of the target;
a pressure-sensing unit disposed in the closed space for sensing the air pressure in the closed space to generate a pressure signal and send the pressure signal to the control unit; and
a light-emitting unit disposed at the base and electrically connected with the control unit,
wherein when the deformable lamp body is deformed so that the pressure signal reaches a predetermined value, the control unit controls the light-emitting unit according to the color signal, so that the light-emitting unit emits the light corresponding to the color signal toward the deformable lamp body.

2. The lamp according to claim 1, wherein the material of the deformable lamp body is silicone or rubber.

3. The lamp according to claim 1, further comprising:
a switch and a power supply unit, wherein the switch is disposed at the base and electrically connected with the power supply unit, the power supply unit is disposed at the base and electrically connected with color-sensing unit, the control unit, the pressure-sensing unit and the light-emitting unit.

4. The lamp according to claim 1, wherein the light-emitting unit is a light-emitting diode or an organic light-emitting diode.

5. The lamp according to claim 4, wherein the light-emitting unit is a hybrid red, blue and green light-emitting diode.

6. The lamp according to claim 1, further comprising:
a wireless transmission unit disposed at the base and electrically connected with the control unit.

7. The lamp according to claim 6, wherein the wireless transmission unit is an infrared ray transmission unit.

8. The lamp according to claim 6, further comprising:
a lampshade having a charging base and a signal-receiving unit, wherein the lamp is disposed at the charging base and electrically connected with the charging base, the wireless transmission unit sending the color signal to the signal-receiving unit.

9. The lamp according to claim 1, wherein the deformable lamp body further comprises a neck portion, the neck portion has a thread, the deformable lamp body is coupled with the base through the thread.

10. The lamp according to claim 1, wherein the color-sensing unit comprises a light source and a receiver.
